(19) United States
(12) Patent Application Publication
(10) Pub. No.: US 2016/0208742 A1
(43) Pub. Date: Jul. 21, 2016

(54) DiscThruster, pressure thrust based aircraft engine

(71) Applicant: John Bradley Pande, North Salt Lake, UT (US)

(72) Inventor: John Bradley Pande, North Salt Lake, UT (US)

(21) Appl. No.: 14/599,495

(22) Filed: Jan. 17, 2015

(51) Int. Cl. F02K 9/42

(52) U.S. Cl. CPC F02K 9/42

(57) ABSTRACT

A aircraft propulsion device called DiscThruster™ which creates thrust in the form of pressure thrust, as opposed to momentum thrust, wherein a thin round DiscThruster disc 2 spins about its disc rotation axis being driven by a turboshaft engine, wherein the disc 2 exhibits a series of ring-like concentric circumferential disc zones 4 on its flat surface, beginning from the innermost radius out to the circumferential edge of the disc 2, such that each disc zone 4 contains a plurality of interconnected components in series, including a fluid pump 22, a converging only sonic choking nozzle 23, and a fluid collector 24, wherein low sonic velocity two-phase working fluid 9 pressurized by a spinning centrifugal pump 22, passes through and sonically chokes in the nozzle 23 creating both pressure thrust and momentum thrust, and enters the external atmospheric pressure environment 8 where it travels some distance away before being captured by the circumferential scoop-like fluid collector 24 through centrifugal forces that cancel momentum thrust in the direction of pressure thrust, and is then redirected to the next adjacent radially outward disc zone 4, where the cycle is repeated until the fluid 9 reaches the radially outermost disc zone 4, where it is captured and recycled back to the radially innermost disc zone 4, such that no fluid 9 leaves the system.

### BACKGROUND OF THE INVENTION

1. Field of the Invention

This invention relates to a pressure thrust propulsion air breathing aircraft engine, specifically to improved specific fuel consumption over-state-of-the-art turbofan engines.

2. Description of the Related Art

Air breathing turbofan aircraft engines and rocket engines generate thrust based on the rocket equation. Rocket equation thrust is the sum of momentum thrust and pressure thrust, such that state-of-the-art turbofan engines are designed to primarily maximize momentum thrust and not pressure thrust. Pressure thrust is generated when there is differential pressure across the nozzle exit plane, such that this differential pressure times nozzle exit plane cross-sectional area equals pressure thrust. Thereafter this principle is applied to replacement of modern turbofan engines (as well as open rotor fans and derivatives); whose mature momentum thrust technology is plateauing in terms of specific fuel consumption efficiency gains.

For a descriptive example, engineers design momentum thrust rocket engines with gas expanding nozzles to maximize velocity of gasses leaving the nozzle exit plane. This occurs when pressure just inside the nozzle exit plane equals the external atmospheric pressure environment just outside the nozzle exit plane, being called perfectly expanded flow. At this ideal condition the pressure thrust component is zero. Any delta pressure across the nozzle exit plane, being called under or over expanded flow, reduces desired rocket engine propulsive efficiency, otherwise referred to as specific impulse. However, there are rocket engines forced to operate in off ideal nozzle expansion flow conditions, maximizing available specific impulse as possible using a mix of both momentum thrust and pressure thrust, where momentum thrust dominates. As a working example, the fixed nozzle expansion ratio chosen for ground launched rocket engines, to maximize overall performance, is a compromise between atmospheric conditions at ground level and motor burnout at high altitude. Exhaust gas flow is not perfectly expanding in the nozzle between ground and burnout altitude due to changing atmospheric pressure conditions. Yet at times during flight pressure thrust is being generated, sometimes both positively and negatively, being accounted for in the nozzle's fixed expansion ratio design.

Still another example of not designing a rocket engine for perfectly expanded flow, rather a mix of both momentum dominated thrust and pressure thrust are microthrusters found on spacecraft. Spacecraft microthrusters typically strive for extremely high propellant exit velocities to achieve high specific impulse, allowing them to trade very small fuel fractions for larger payload fractions. For this reason microthrusters use low molecular weight gases like Xenon, since these gasses have high sonic choking velocities, unlike two-phase fluids. The problem is high specific impulse engines require high electrical power that is limited by the spacecraft's solar cell array wing area. Consequently these super fuel efficient microthrusters end up with only a minimum of usable thrust.

To counter microthruster low thrust U.S. Pat. No. 8,613,188 to Stein, et al. (2013) proposes modifying the nozzle aft end and other downstream geometry, increasing the pressure thrust component for this very low 1 millinewton (0.000225 pound) thruster. In all 47 claims propellant (working fluid) is limited exclusively to a “gas”. This teaches towards a propellant with high exit velocity for a high momentum thrust, and teaches away from a low sonic velocity choking fluid baseline as the case for the 100% pressure thrust goal DiscThruster engine. As a working example, the DiscThruster engine uses a low sonic velocity two-phase working fluid like water and steam having a sonic velocity typically<46 meters/second (150 feet/second). This contrasts sharply with microthrusters operating as ion thrusters where propellant exit velocity using gaseous xenon is up to 50,000 meters/second (164,000 feet/second). And still furthermore, the microthruster patent expresses unsupported performance claims including doubling thrust level, without referencing specific impulse impact. In reality designing microthruster aft end geometry to minimize extreme velocity propellant viscous friction flow losses may be the real significant source of claimed gains in thrust and performance.

Two-phase low sonic velocity choking spray nozzles are already practiced in a mired of industries for delivering an atomized spray of water or other liquid droplets, typically for cooling or evaporation towers. Low sonic velocities of two-phase flow reduce pumping horsepower, a significant cost savings advantage for commercial spray systems, while aiding in mixing and atomization of liquid leaving the nozzle. As an example, Caldyn Apparatebau GmbH of Germany designs and manufactures water and air two-phase spray nozzles with sonic choking sections and virtually no diverging nozzle section, whose art teaches away from being thrusting devices both in design, design intent, application, and operation. Rather, the art teaches towards producing finely atomized mists for cooling towers with well-defined micron sized particles leaving the nozzle with predictable spray footprint patterns. And still another example, Siemens AG two-phase water and gas mixture nozzles used in ceiling fire extinguishing systems requiring fine atomized liquid mists, have numerous nozzle designs, many not requiring sonic choking at all, teaching away from an efficient thrust propulsion device.

The water rocket U.S. Pat. No. 7,891,166 B2 by Al-Qutub, et al. (2011) is a momentum thrust based rocket, wherein high pressure gas is injected into a nozzle chamber through its perforated walls, expanding and accelerating fluid out of the diverging nozzle, being an enhancement over conventional all water rockets by increasing fluid velocity leaving the nozzle. This patent teaches the term two-phase nozzle as a gas energizing a liquid to accelerate the mixture out of the nozzle with the highest velocity possible, thus teaching away from the DiscThruster engine approach of using two-phase fluid with the lowest fluid exit velocity as is practical, with the minimum momentum thrust component as possible. And furthermore, the diverging nozzle section design further increases fluid exit velocity for maximum momentum thrust, thereby minimizing pressure thrust and teaching away from the design intent and operation of the DiscThruster engine.

U.S. Pat. No. 7,784,267 B2 by Tobita, et al. (2010) is a variation on the basic pulse detonation engine with enhancements, including an outer ducted fan in the airstream driven by detonation engine gasses, such that it is a good example teaching towards momentum thrust engines and away from DiscThruster engines. Pulse detonation engines show no art towards using slow moving two-phase or other low sonic velocity choking fluids or propellants. In fact current art teaches towards maximizing pressure shock velocity along the combustion tube length, pointing towards momentum thrust and away from pressure thrust. And still further pulse detonation art teaches towards using lighter molecular weight gasses such as Hydrogen gas to maximize sonic velocity.

U.S. Pat. No. 8,419,378 B2 by Fenton, et al. (2013) is a claimed improvement of the conventional liquid pump by using high velocity gas or liquid (termed “transport fluid”) injected in the general direction of the fluid (termed “working fluid”) to be pumped or transported. Momentum of high velocity injected transport fluid imparts momentum to the working fluid, pumping or transporting it. In one embodiment transport fluid is high pressure injected steam, adding both momentum in flow velocity and thermal energy in the form of expanding gas. In a claimed improvement working fluid or fluids are atomized to form a dispersed vapor/droplet flow regime with locally supersonic (not sonic like the DiscThruster Engine) flow conditions within a pseudo-vena contracta, resulting in the creation of a supersonic condensation shock wave. Pseudo-vena contracta flow is essentially a fluid flow “necking” phenomenon forming a virtual converging diverging nozzle, allowing working fluid to sonically choke, expand, and accelerate supersonically downstream. The patent further claims using a conventional converging diverging nozzle to maximize working fluid nozzle velocity, again teaching away from DiscThruster engine's low sonic velocity pressure thrust operation. In the patent discussion section a practical application for “marine propulsion systems” is stated, teaching towards high exit velocity and high momentum thrust, based on a converging diverging nozzle, either through a pseudo-vena contracta or conventional converging diverging nozzle, thus teaching away from a pressure thrust based DiscThruster engine.

F. R. Goldschmied, “Fuselage Self-Propulsion by Static-Pressure Thrust: Wind-Tunnel Verification”, American Institute of Aeronautics and Astronautics AIAA-87-2935, 1987, USA is a self-propelled axisymmetric streamlined body with slot suction boundary layer control at the aft end with additional jet gas discharge (i.e. momentum thruster). This elongated football like fuselage geometry reduces overall drag by controlling the boundary layer on the aft end of the body. By drawing air (sucking) through a circular slot located at the aft end of the body, airflow flowing over the aft body section does not separate from the local surface, avoiding a low pressure condition. This higher pressure acting on the aft body when boundary layer control is employed is referred to by the author as “static-pressure thrust”, and reduces overall body drag. Boundary layer control systems applied to missiles and aircraft fuselages reduce drag as opposed to creating thrust, thus teaching away from a DiscThruster engine approach.

Review of prior art shows many variations, permutations and marginal improvements on the fundamental momentum thrust based engines. Whereby, said prior art teaches away from a pressure thrust based propulsion engine, rather to one dominated by momentum thrust.

2. Objects and Advantages

Modern air breathing turbofan engines are optimized around maximizing momentum thrust by imparting greatest velocity change on expended core and bypass air mass as possible, with minimum internal and external friction loss as possible. This multi-decade mature technology has reached both its thermodynamic and practical fuel efficiency limits. One challenge to fuel efficiency for turbofan engines is their mismatched requirements for large static takeoff thrust and small high altitude cruise thrust. For example, a 133.4 kilonewton (30,000 pound) static takeoff thrust turbofan engine may only require about 28.0 kilonewtons (6,300 pounds) of thrust once at high altitude cruise, or about 21% of takeoff thrust, forcing the same engine to operate over a very wide performance range. High speed high altitude cruise becomes inefficient since velocity of incoming air and delta velocity change imparted by the engine is relatively small, causing specific fuel consumption to nearly double over static takeoff thrust. Momentum based aircraft engines, including ultra high bypass turbofans, geared turbofans, open rotor fans, and conventional propellers with highly swept blades allowing them to operate at high Mach numbers are plateaued in specific fuel consumption efficiency gains, do not have a path to significant future gains, and are overall a less efficient means of aircraft propulsion.

In the present invention, the following means are employed to solve the above problems. The DiscThruster engine, a pressure thrust based engine replaces large and small air breathing momentum based turbofan engines with a 50% minimum goal in reduced high altitude cruise specific fuel consumption, benchmarked against the modern 133.4 kilonewton (30,000 pound) thrust class CFM International LEAP-1C engine. Since the DiscThruster engine in one embodiment is powered by a commercial off-the-shelf turboshaft engine already manufactured by current turbofan engine makers, it makes sense they would produce the new engine, greatly compressing traditional long engine development times and large budgets, bringing this revolutionary engine to market quickly. A 50% fuel burn reduction revolutionizes the aircraft propulsion market, making turbofan technology obsolete the first day the DiscThruster engine comes to market.

The spinning DiscThruster disc is relatively compact, being about one meter (3.3 feet) in diameter and just a few centimeters thick for a 133.4 kilonewton (30,000 pound) thrust class engine, not necessarily being the preferred embodiment. For this example a relatively small 3,729 to 5,966+kilowatt (5,000 to 8,000+ shaft horsepower) class turboshaft engine (either as a single or sum of multiple engines) is required to spin and energize the DiscThruster disc at full rated static thrust. At high speed high altitude cruise DiscThruster engines, like turbofan engines provide only about 21% of takeoff thrust. Since DiscThruster engines operate on the basis of pressure thrust and not momentum thrust, their thrust output is largely independent of aircraft speed. And furthermore, counter intuitively DiscThruster disc propulsive efficiency actually goes up significantly as thrust is reduced, such that specific fuel consumption is lower at high altitude cruise than at maximum takeoff thrust when a two engine scheme is being employed. Therefore, in one embodiment the DiscThruster disc is powered through a transmission by two commercial-off-the-shelf turboshaft engines where one is designated the high power engine and the other the low power engine. For takeoff thrust both engines spin the DiscThruster disc. For climb the high power engine spins the disc at a lower but efficient power setting and the low power engine is decoupled and shut down. Upon approach to and reaching high altitude cruise the low power engine, sized and optimized for low specific fuel consumption at cruise is restarted and the high power engine decoupled and shut down. This two engine fuel savings approach is not practical for momentum based turbofan engines since at high altitude high speed cruise, significant capacity of the single large engine is required, since it must operate at high engine shaft revolutions, while imparting relatively small velocity change on high speed incoming air, producing only low thrust.

Aircraft reverse thrust needs in one embodiment are served by placing similar DiscThruster disc circumferential disc zones, producing pressure thrust, primarily near the outer circumference, on the back side of the disc, the side facing oncoming air of the moving aircraft. When commanding reverse thrust moving louvers open, exposing forward facing pressure thrust producing circumferential disc zones. Louvers close when thrust reversal is not required maintaining a continuous like surface of the aerodynamic engine faring. In still another embodiment the aforementioned thrust reversal means are located near the forward end of the aerodynamic engine fairing performing a similar function. In yet another embodiment, conventional thrust reversing fans driven by the turboshaft engine(s) are employed.

In another embodiment the engine aerodynamic fairing exhibits low aerodynamic drag features including aft end boat tail like geometry and active and passive base bleed. Base bleed includes but is not limited to diverting turboshaft exhaust gasses to the aft end, adding a circumferential fan compressor blade to reduce base drag by injecting higher pressure air in a controlled boundary layer manner to the aft end, directing engine cooling and other heat exchanger outlet air to the aft end, employing low base drag reducing conical shaped geometry DiscThruster discs, and employing deployable aft end base bleed drag reducing aerodynamic fairings for given flight modes. And still another embodiment reducing aerodynamic engine fairing drag and base drag is by submerging, partially or fully the fairing within the aircraft's wing cross-section, within other aircraft structures, including but not limited to the aft aircraft fuselage to reduce overall drag.

And furthermore, the DiscThruster engine opens up new enabling technology platforms and revolutionary missions including but not limited to: (1) stored on board oxidizer and fuel powered heavy lift engines for space launch vehicles, (2) single-stage-to-orbit payload launching vehicles employing one or both air breathing and stored on board oxidizer, (3) commercial aircraft launching to and from minimum vacuum of space altitudes while cruising at sub orbital velocity and maintaining altitude with constant vertical thrusting and sub orbital acceleration lift, and then decelerating in space prior to atmospheric entry, eliminating majority of thermal protection system needs, and finally conventionally landing (as well as taking off) at commercial airports, spanning the world's longest flight routes in about two hours, (4) military Prompt Global Strike vehicles, (5) high delta velocity interplanetary scientific missions including a rapid transit manned mission to Mars, (6) electric and hybrid powered vehicles, (7) vertical takeoff and landing (VTOL) aircraft, including replacing rotary wing aircraft, (8) land vehicle propulsion and (9) water surface vehicle propulsion. The forth coming description is generic and not necessarily describing the preferred embodiment since there are so many applications, each with their unique and specific design and performance requirements.

### SUMMARY OF INVENTION

The DiscThruster engine as relating to turbofan engine replacement in one embodiment comprises a high power engine, usually a commercial-off-the-shelf turboshaft engine, and a thin round flat like spinning disc called the DiscThruster disc. The turboshaft engine couples through a transmission to the DiscThruster disc at its disc rotation axis, via a center axis drive shaft, causing the DiscThruster disc to spin. The DiscThruster disc's flat like surface is proportioned into a number of concentric ring-like circumferential disc zones, starting near the inner radius, out to about the circumferential edge of the disc. Circumferential disc zones are sufficiently radially wide, containing a plurality of discrete component groups. Each group is made up of a fluid pump, a sonic choking nozzle, and a fluid collector, all connected usually in series. In one embodiment working fluid in the form of a low sonic choking velocity two-phase fluid enters the fluid pump, being a radial vane like centrifugal pump. Working fluid passing through the fluid pump is both pressurized and caused to flow to the adjacently connected sonic choking nozzle. Working fluid entering the sonic chocking nozzle's, nozzle converging section, sonically chokes in the minimum cross-sectional area with an accompanying large pressure drop, and passes through and out the nozzle exit plane into the external atmospheric pressure environment. Since the sonic choking nozzle exhibits no aft end diverging section (although a small end chamfer may exist) as with conventional rocket nozzles, working fluid is not appreciably expanding or accelerating to high speeds out of the nozzle as with conventional converging diverging rocket like nozzles. The difference in pressure across the nozzle exit plane times cross-sectional area of the nozzle exit plane equals the pressure thrust of each nozzle. Summing pressure thrust of all sonic choking nozzles equals DiscThruster engine total thrust. Working fluid leaving the nozzle exit plane travels some distance away in a tangential like rising path, allowing the external atmospheric pressure environment to exist just outboard of the nozzle exit plane, maximizing delta pressure across the exit plane, thereby maximizing pressure thrust. Airborne working fluid eventually reaches the fluid collector, being in one embodiment a curved wall like circular ring located on the outer larger circumferential perimeter of the circumferential disc zone. The circular ring exhibits a circumferential inward tilted wall such that airborne working fluid making contact with the wall is collected and then directed downward (toward the disc surface) by circumferential forces of the spinning DiscThruster disc. Collected working fluid passes to the next radially outward and adjacent circumferential disc zone, consisting of a near identical fluid pump, sonic choking nozzle, and fluid collector as the previous circumferential disc zone. Working fluid moves in an increasing radial direction from adjacent to adjacent circumferential disc zone until reaching the most outer circumferential disc zone, exiting into an open air gap and entering a physically disconnected and independently spinning working fluid accumulator. The working fluid accumulator collects working fluid, and in one embodiment extracts kinetic energy in a fluid turbine before directing it to the working fluid conditioner, pump, and recycler. In one embodiment the fluid turbine wheel operates at approximately half the rotational velocity of the circumferential disc zone providing the fluid, such that working fluid exiting the turbine wheel has nearly no remaining velocity. Extracted fluid turbine power energizes base bleed systems, generators, supplements rotating DiscThruster disc via mechanical gearing or electrical power transfer, powers auxiliary thrust systems, etc. The generally stationary working fluid conditioner, pump, and recycler adjusts fluid state temperature, pressure, etc. and pumps working fluid back to the radially innermost circumferential disc zone, completing a closed loop working fluid recycle where all fluid is ideally retained.

Several embodiments to a basic working description include but are not limited to a DiscThruster disc with a rotating disc base, where fluid pump, sonic choking nozzle, and fluid collector components located in all circumferential disc zones rigidly attach to and spin with the DiscThruster disc. In another embodiment of the DiscThruster disc with a non-rotating disc base, only the combined fluid collector and fluid pump spin, while all other components are stationary (non-spinning) and attached to the non-rotating disc base. And still in another embodiment for a rotating base (although a non rotating base is equally feasible) configuration the DiscThruster conic disc exhibits a conic cross-section as opposed to the flat like DiscThruster disc discussed previously. Its geometry and orientation is like a rocket nozzle in appearance, operating in the same manner as the rotating base DiscThruster disc.

For both flat like DiscThruster discs, including the rotating disc base and non-rotating base, as well as the DiscThruster conic disc, a multi concentric disc embodiment is envisioned. In one embodiment the multi concentric disc approach more optimally sizes circumferential disc zones and greatly reduces working fluid kinetic energy entering the working fluid accumulator. Such that one large disc is divided into two or more independently rotating discs sharing the same approximate spinning plane and disc rotation axis. The large disc is divided along circumferential lines, where there is a small open air gap at the circumferential line, separating one spinning disc from another adjacent spinning disc. Each independent disc contains and operates interconnected circumferential disc zones as previously discussed. Working fluid leaving the radially innermost concentric spinning disc's outer circumference passes across the open air gap to the next adjacent spinning concentric disc's inner circumference, moving in a radially increasing direction. Generally the rotational speed of each spinning concentric disc decreases by half as you go radially outward from adjacent concentric disc to adjacent concentric disc. Working fluid passing across the open air gap from adjacent to adjacent concentric disc transfers fluid to each successive disc but also imparts spinning torque to each disc through an impulse like water turbine. In one embodiment a gear transmission is incorporated to couple and maintain consistent spinning gear ratios between spinning concentric discs. In a further embodiment this gear transmission transfers power to each concentric disc to supplement or replace the previously mentioned impulse like water turbine. For the case of the DiscThruster conic disc, each independently concentric spinning disc may have one or more conic shaped walls containing numerous circumferential disc zones, exhibiting a shark tooth like cross-section. Working fluid reaching the radially outer most spinning concentric disc's circumferential disc zone, passes across the open air gap to the working fluid accumulator, where explained earlier makes a fluid path back to radially innermost independent spinning concentric disc's radially innermost circumferential concentric disc zone to complete the fluid recycle loop.

There are several working fluid embodiments for different performance applications, all with a common goal of achieving the lowest practical sonic choking velocity, lowest internal friction loss, ease of fluid handling, lowest environmental impact, etc., for the greatest overall practical propulsive efficiency as measured by delivered specific fuel consumption. Two-phase fluids identified for this example as the working fluid, comprise a gas and liquid mixture in thermo-equilibrium or in non-thermo-equilibrium. The gas and liquid can be identical substances just in different thermodynamic states, or they can be different substances all together. These substances can also be mixes of multiple gasses and/or multiple liquids working together to achieve the lowest practical sonic choking velocity. In one embodiment they may also include three-phase mixes with solid or semi-solid components. Some fluids may include cryogenic, room temperature or high temperature injection of liquid, jell or solid particles into the majority fluid to create two-phase like low sonic velocity fluids, or they may produce gasses through decomposition or reaction with themselves, the local environment, or substances in the working fluid. These particles may be introduced by the working fluid conditioner, pump, and recycler, or be injected directly into each sonic choking nozzle. In still another embodiment, particles (or the working fluid itself) are magnetic or electrostatic attracting/repelling to local generated fields that guide and direct them in at least one of the basic components (e.g. fluid pump, sonic choking nozzle, fluid collector), for example particles support or dominate in the process of transferring (and pressurizing in some embodiments) working fluid from the sonic choking nozzle to the fluid collector. Other working fluid embodiments include but are not limited to multi-phase fluids, fluids at or near the thermodynamic saturated line, specifically engineered low sonic velocity choking fluids of one or more components and other combinations thereof. In another embodiment two-phase fluids can enter the nozzle as a discrete liquid and compressed gas, mixing into a two-phase or multi-phase working fluid upstream of the nozzle sonic choking point. Some working fluids use ultrasonic mixing energy, fluid stream disruptors, reverse flow mixing, friction heating as result of passing through disc components/fluid passageways, spinning centrifugal forces, method of maintaining two-phase flow through the nozzle sonic section under high normal (right angle like) acceleration loading that avoids liquid and gas separation, multiple mixtures of fluids with different states for the same pressure and temperature having the effect of a low sonic choking point, etc., all achieving preferable low sonic chocking fluid states upstream from the nozzle sonic choking point. In one embodiment example a two phase working fluid is formed by combining elevated temperature kerosene jet fuel with a small quantity of alcohol, such that the alcohol flashes to a gas as the second (gas) phase being later utilized by the powerplant as fuel. Still other embodiment examples include situations where working fluid is not 100% recovered by the fluid collector as in general losses, compressed air injection, turboshaft combustion gasses, independently produced combustion gasses, and cryogenic liquid or gaseous, including nitrogen. In one embodiment cryogenic liquid nitrogen is stored in a reservoir on board the aircraft as the working fluid where losses are replenished “on the fly” by a state-of-the-art ambient air extracting nitrogen liquefaction system. And still another embodiment where aircraft fuel (e.g., kerosene) circulates as a partial or complete heated working fluid, where any small losses are 100% recovered, recycled or combusted.

And in still another embodiment the fluid pump operates in a reciprocating like motion as opposed to a pure rotary motion as previously discussed. Reciprocating like motion can be back and forth along the same path, a curved path in a continuous one way circular like returning circuit, an oval path, a spline like path, a path in three dimensions, etc., with the purpose of pressurizing and transporting working fluid from the fluid pump to the sonic choking nozzle. For this type of reciprocating like pump, the single or plurality of sonic choking nozzles may be located on or submerged to a flat or curved surface (generally a non rotating surface), being macro or microscopic in size, such that the fluid collector is integrated into the local vibration like, reciprocating like motion, to capture and collect working fluid leaving the sonic choking nozzle into the external atmospheric environment. Once working fluid is intercepted in the external pressure environment, it is collected by the fluid collector and redirected back to the fluid pump.

And yet another DiscThruster engine embodiment using pressurized gasses typically from a combustion process (e.g., rocket motor engine combustion gases) at typically very high pressure (although low pressure fluids, including cryogenic fluids) are “seeded” with a sonic velocity reducing component creating a two-phase like fluid flow sonic velocity behavior (although other velocity reducing mechanism and components can be used) that exits a sonic choking nozzle as previously discussed. This approach usually produces pressure thrust where the “seed” that enters and never returns from the external atmospheric pressure environment, is a comparatively small fraction.

### BRIEF DESCRIPTION OF THE DRAWINGS

FIG. 1 shows a first embodiment of the DiscThruster engine integrated into an aircraft engine application, including the engine-to-wing pylon according to the present invention, being a perspective view with partial cutaway showing component interconnectivity and functionality.

FIG. 2 shows a second embodiment of the flat-like geometry DiscThruster disc according to the present invention, being a perspective view of the overall disc showing circumferential disc zones on the disc surface, DiscThruster center axis driveshaft, disc rotation axis, and other features where fluid pump, sonic choking nozzle, and fluid collector are rigidly attached to and spin with the rotating disc base.

FIG. 3 shows a third detailed embodiment of the flat-like geometry DiscThruster disc according to the present invention, being a partial perspective cross-sectional detail view of the disc showing only an approximate 45 degree wedge sweep about the disc rotation axis of the actual 360 degree continuous flat like section, showing only a limited number of the basic thruster embodiment elements where the fluid pump, sonic choking nozzle, and fluid collector rigidly attach to and spin with the rotating disc base.

FIG. 4 shows a forth detailed embodiment of the conical-like geometry DiscThruster conic disc according to the present invention, being a partial perspective cross-sectional detail view of the disc showing only an approximate 25 degree wedge sweep about the disc rotation axis of the actual 360 degree continuous conic section, showing only a limited number of the basic thruster embodiment elements where the fluid pump, sonic choking nozzle, and fluid collector rigidly attach to and spin with the rotating disc base.

FIG. 5 shows a fifth detailed embodiment of the flat-like geometry DiscThruster disc according to the present invention, being a partial perspective cross-sectional detail view of the disc showing only an approximate 25 degree wedge sweep about the disc rotation axis of the actual 360 degree continuous flat like section, exhibiting only a limited number of the basic thruster embodiment elements where the fluid collector and fluid pump rotate about the disc center axis, while the non-rotating disc base is stationary and the sonic choking nozzle is rigidly attach to it.

### LIST OF FIGURE COMPONENT NUMBER AND NAME

1. DiscThruster engine
2. DiscThruster disc
3. aerodynamic engine fairing
4. circumferential disc zone
5. inner circumferential disc group
6. mid circumferential disc group
7. outer circumferential disc group
8. external atmospheric pressure environment
9. working fluid
10. working fluid accumulator
11. conditioner input fluid line
12. working fluid conditioner, pump, and recycler
13. conditioner output fluid line
14. center axis drive shaft
15. transmission
16. high power drive shaft
17. low power drive shaft
18. high power engine
19. low power engine
20. engine-to-wing pylon
21. rotating disc base
22. fluid pump
23. sonic choking nozzle
24. fluid collector
25. radial vane
26. nozzle chamber
27. converging section
28. nozzle exit plane
29. nozzle exit plane orifice
30. open air gap
31. tilted wall
32. DiscThruster conic disc
33. non-rotating disc base
34. nozzle-to-collector gap
35. rotating arm fluid collector
36. disc rotation axis

### DETAILED DESCRIPTION

Hereunder is a description of a first embodiment of a DiscThruster engine 1 integrating into an aircraft application, including a engine-to-wing pylon 20 according to the present invention with reference drawings. Since this invention covers a wide multitude of propulsion applications, installation formats, thrust magnitudes, operational environments, wherein performance requirements vary widely, embodiments described herein are not necessarily the preferred embodiment, rather a static and operational description of one or more generic embodiments of the invention.

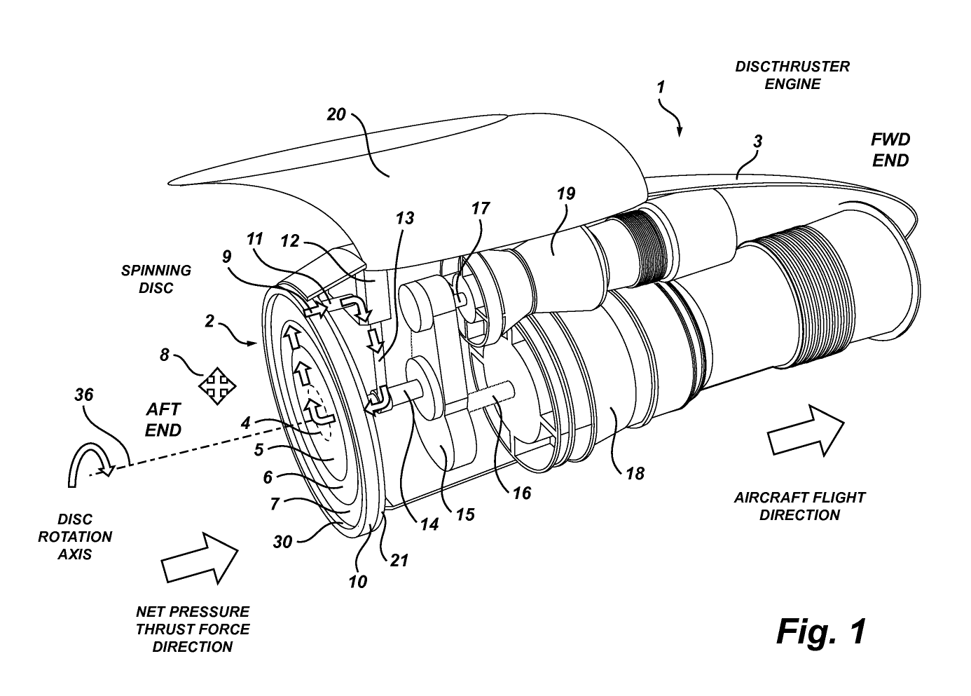

FIG. 1 shows a first embodiment of the DiscThruster engine 1 integration into an aircraft engine application, being a perspective view with partial cutaway showing component interconnectivity and functionality. Some element sizing, positioning, and other physical attributes are simplified to better illustrate overall functionality of the system. A DiscThruster disc 2 located at the aft end of the DiscThruster engine 1, exhibits a configuration where the engine is positioned under an aircraft wing. When the aircraft flies forward, outside ambient air flows from the forward end to the aft end of a aerodynamic engine fairing 3. The DiscThruster disc 2 aft facing surface is divided into a plurality of ring like concentric circumferential partitions, each with a given radial thickness, where each partition is called a circumferential disc zone 4, such that each zone communicates in a fluidic manner to adjacent zones. Combining together numerous adjacent circumferential disc zones 4 and labeling them as separate groups is performed to describe their functionality. These groups consist of a inner circumferential disc group 5, a mid circumferential disc group 6, and a outer circumferential disc group 7. All groups have a view of and communicating pressure access to a external atmospheric pressure environment 8. The rotating DiscThruster disc 2 utilizing a working fluid 9 generates pressure thrust within each circumferential disc zone 4. Working fluid 9 enters the radially innermost circumferential disc zone 4 contained within the inner circumferential disc group 5, travels from adjacent disc zone to disc zone until it reaches the radially outermost disc zone, and passes to the adjacent radially innermost disc zone of the mid circumferential disc group 6, where the fluid passes radially outward from adjacent disc zone to disc zone until the fluid reaches the radially innermost disc zone of the outer circumferential disc group 7, where the fluid passes radially outward from adjacent disc zone to adjacent disc zone, until the fluid reaches the radially outermost disc zone. Working fluid 9 exits the outer circumferential disc group 7, passes across a open air gap 30 and enters a working fluid accumulator 10 that is not physically attached to the DiscThruster disc 2, independently spinning (or static in one embodiment) on a separate axis that is coaxial to the disc 2. The working fluid accumulator 10, depending on embodiment application, extracts kinetic energy from working fluid 9 that is tangentially exiting the radially outermost circumferential disc zone 4 of the outer circumferential disc group 7, for example using a reaction or impulse water turbine like, steam turbine like device, and in another embodiment separating liquid and gas components from the working fluid 9, slowing fluid velocity to near zero. A conditioner input fluid line 11 passes working fluid 9 from the working fluid accumulator 10 to a working fluid conditioner, pump, and recycler 12. The working fluid conditioner, pump, and recycler 12 conditions working fluid 9 to a required thermodynamic state in terms of temperature (e.g., adding or taking away heat with a heat exchanger), pressure, saturation, adjusting liquid to gas ratio, adjusting component constituent ratio, adding low boiling point fluid to higher boiling point fluid to create a two phase fluid, adding solid particles, etc. Working fluid 9 leaving the working fluid conditioner, pump, and recycler 12 enters a conditioner output fluid line 13, attaching to and fluidically communicating with a center axis drive shaft 14, located at a disc rotation axis 36 of the DiscThruster disc 2, allowing fluid to flow through the hollow shaft 14 back to the radially innermost circumferential disc zone 4 of the inner circumferential disc group 5, thereby recycling the fluid. The center axis drive shaft 14 mechanically connects to the DiscThruster disc 2 at the disc rotation axis 36. The embodiment shown in this figure points to a rotating disc base 21 mechanically attaching to the back side of the DiscThruster disc 2. Rotating the center axis drive shaft 14 imparts power to the DiscThruster disc 2 in the form of rotational torque, causing circumferential disc zones 4 to produce pressure thrust. The center axis drive shaft 14 connects to a transmission 15, which connects to both a high power drive shaft 16 and a low power drive shaft 17. The high power drive shaft 16 connects to a high power engine 18, and the low power drive shaft 17 connects to a low power engine 19. In an operational embodiment example, both the high power engine 18 and low power engine 19 couple to the high power drive shaft 16 and low power drive shaft 17 respectively, and to the transmission 15 which connects to and drives the center axis drive shaft 14, spinning the DiscThruster disc 2. For an aircraft application embodiment example only the transmission 15 is a state-of-the art reduction gear transmission, while both the high power engine 18 and low power engine 19 are adapted commercial-off-the-shelf turboshaft aircraft engines. In this turboshaft engine figure illustration example only, the power takeoff connects to the power turbine section at the aft end of the engine, although in other embodiments the engines may be positioned differently.

For aircraft takeoff the DiscThruster engine 1 is required to produce full thrust where both the high power engine 18 and low power engine 19 engage, spinning the DiscThruster disc 2. For aircraft climb only the high power engine 18 couples to and spins the DiscThruster disc 2 in the manner described previously, and the low power engine 19 decouples and shuts down. For high altitude aircraft cruise only, operating at the overall lowest specific fuel consumption possible, the low power engine 19 couples to the DiscThruster disc 2, again in the manner described previously, while the high power engine 18 decouples and shuts down. The aerodynamic engine fairing 3 encloses the majority of engine components to reduce aerodynamic drag and not interfere with the DiscThruster disc's 2 aft facing view of the external atmospheric pressure environment 8. The engine-to-wing pylon 20 in this particular embodiment structurally connects to the aerodynamic engine fairing 3 and other underlying engine structure. The upper end of the engine-to-wing pylon 20 attaches to in one embodiment example only, the underside of a commercial aircraft wing.

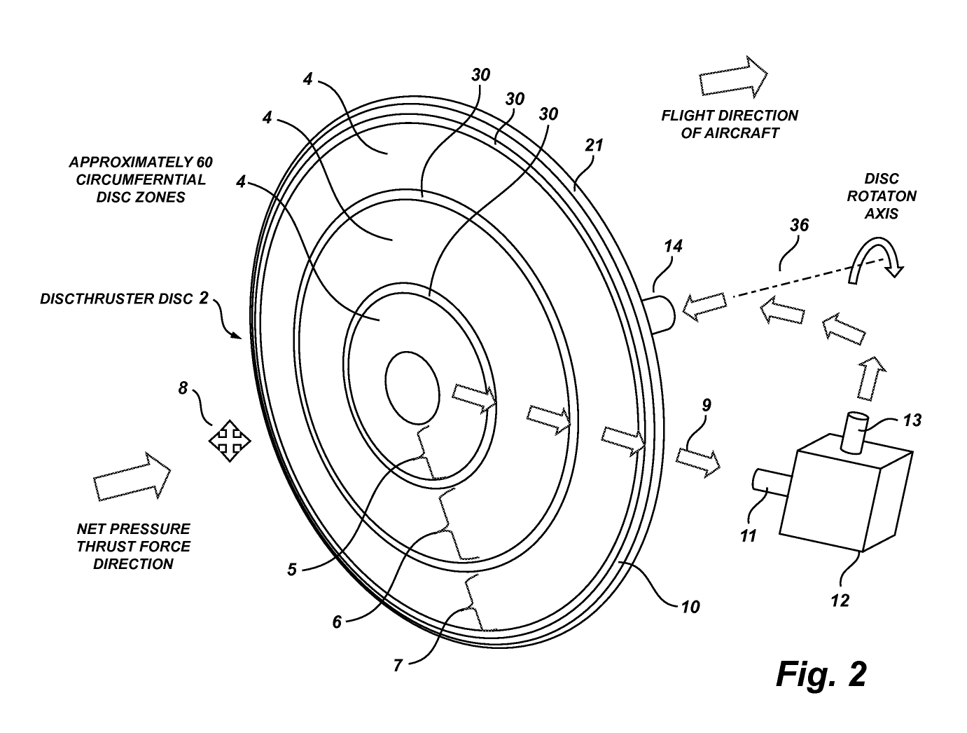

FIG. 2 shows a second embodiment of greater detail and working function of the previous figure's DiscThruster disc 2 according to the present invention, wherein the surface shown exhibits a plurality of circumferential disc zones 4 showing working fluid 9 flowing radially outward, traveling from inner circumferential disc group 5, across the open air gap 30 (for the multi concentric disc embodiment only) to the mid circumferential disc group 6, across the open air gap 30 (for the multi concentric disc embodiment only), to the outer circumferential disc group 7, across the open air gap 30 to the working fluid accumulator 10, to the conditioner input fluid line 11, to the working fluid conditioner, pump, and recycler 12, conditioner output fluid line 13, to and through the hollow shaft of the center axis drive shaft 14 and back to the radially innermost circumferential disc zone 4 of the inner circumferential disc group 5. This figure illustrates the disc rotation axis 36 of the center axis drive shaft 14 and relative location of the external atmospheric pressure environment 8, which is the local atmospheric ambient pressure conditions adjacent to the DiscThruster disc 2 surface shown, having a view and communication with the ambient atmosphere. The embodiment illustrates the rotating disc base 21 mechanically attaching to the back side of the DiscThruster disc 2, and also mechanically attaching to the center axis drive shaft 14, and the inner circumferential disc group 5, mid circumferential disc group 6, and outer circumferential disc group 7. Such that all previously mentioned components rotate with the rotating disc base 21. In the embodiment shown the number of circumferential disc zones 4 on the DiscThruster disc 2, where pressure thrust is created, is very approximately 60, however other embodiments can exhibit just one, hundreds, or even thousands of macroscopic circumferential zones.

In still another embodiment shown in this figure using a similar sub element format as discussed previously there are a plurality of three (although quantities are viable) DiscThruster discs 2 concentric and planar to each other, spinning about the same center disc rotation axis 36, with small circumferential gaps (that is open air gaps 30) separating adjacent spinning discs. In a working example, the inner circumferential disc group 5, mid circumferential disc group 6, and outer circumferential disc group 7 are separated by an open air gap 30, basically a very narrow circumferential gap located between local disc group interfaces, allowing each disc group to independently spin at different rotational speeds about the center axis drive shaft 14 axis. Working fluid 9 leaving the outer circumference of one circumferential disc group, for example the inner circumferential disc group 5, passes radially outward and crosses the open air gap 30 to the next circumferential disc group's radially inner circumference, in this example the mid circumferential disc group 6, and so forth until fluid reaches the radially outermost circumferential disc group, crosses over the open air gap 30 to the working fluid accumulator 10 and recycles back to the radially innermost circumferential disc group via the conditioner input fluid line 11, working fluid conditioner, pump, and recycler 12, conditioner output fluid line 13, and to and through the hollow shaft of the center axis drive shaft 14 in the same method as discussed previously. As part of the embodiment working fluid 9 passes through the open air gap 30 to the next radially outward circumferential disc group, providing both previously mentioned fluid, but also disc spinning rotational power torque using a water turbine like or impulse turbine like device, causing the disc group to spin. In one embodiment, not necessarily the preferred embodiment, circumferential disc group rotational speed drops about in half as you go radially outward from disc group to disc group, where generally the most radially outer disc group 7 has the lowest rotational speed of all disc groups and relatively the lowest fluid kinetic energy.

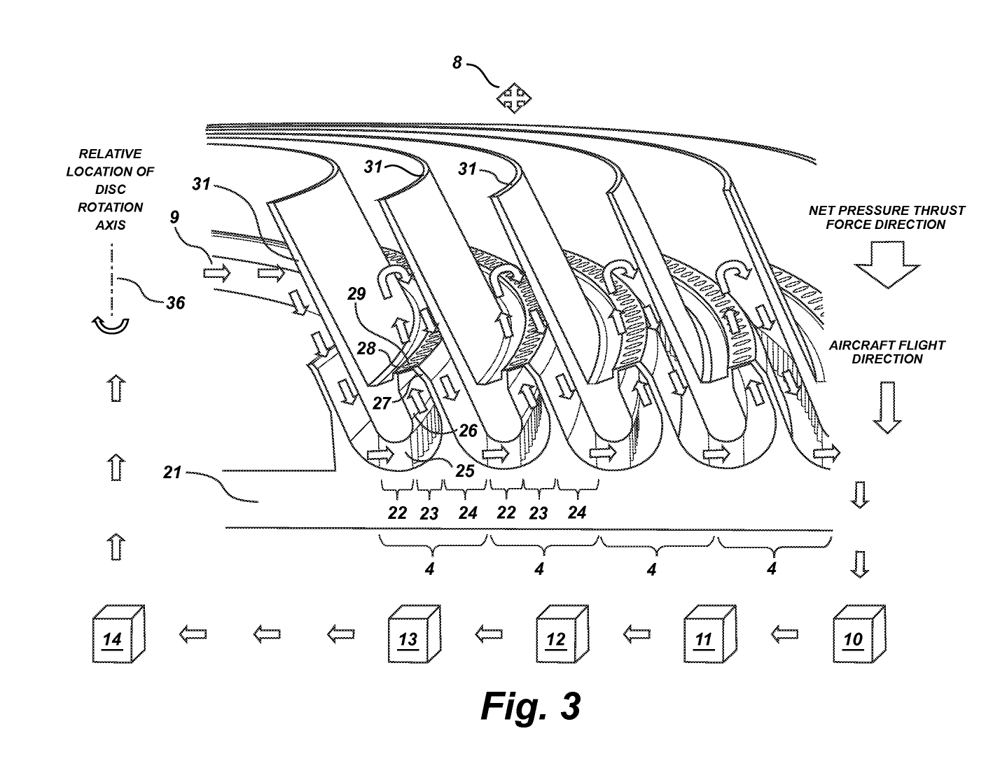

FIG. 3 shows a third embodiment of the DiscThruster disc 2 according to the present invention showing greater detail of the previous two figures, being a partial perspective cross-sectional detail view of the disc illustrating basic thruster embodiment elements contained within the circumferential disc zone 4. They include a fluid pump 22, a sonic choking nozzle 23, and a fluid collector 24, all rigidly attached to and spinning with the rotating disc base 21 about the disc rotation axis 36 (not exact but relative location only for ease of illustrating). In this embodiment the fluid pump 22 contains a radial vane 25. Furthermore in this embodiment the sonic choking nozzle 23 contains a nozzle chamber 26, a converging section 27, a nozzle exit plane 28, and a nozzle exit plane orifice 29. Working fluid 9 within the previous circumferential disc zone 4 enters the radially innermost section of the fluid pump 22, flows through the fluid pump 22 containing radial vanes 25 (which may be a plurality of straight or curved radial vane surfaces in some embodiments) that performs as a centrifugal like pump, pressurizing and pumping fluid to the sonic choking nozzle 23 where fluid sonically chokes (where in another embodiment the fluid pump and sonic choking nozzle are combined and integral together as one). Working fluid 9 enters the nozzle chamber 26, flows to the converging section 27 (where in other embodiments the nozzle chamber and converging section are combined together as one. In still another embodiments radial vanes 25 are contained within the sonic choking nozzle 23, and in yet other embodiments the converging section is a straight cylinder), and out, crossing through the nozzle exit plane 28 and nozzle exit plane orifices 29. Wherein the nozzle exit plane 28 is the geometric flat plane formed by the continuous circumferential edge of each nozzle exit plane orifice 29 end where the working fluid 9 exits. The nozzle exit plane 28 exhibits this co-planar nozzle exit plane orifice 29 geometry for all orifices through which working fluid 9 passes through and out to the external atmospheric pressure environment 8. Nozzle exit plane orifices 29 are shown in this embodiment as round holes. In other embodiments they are elongated round holes, radially staggered round holes, angled slotted holes, a single continuous circumferential hole, numerous stacked holes, and other variations and combinations therein. Working fluid 9 exiting the nozzle exit plane orifices 29, enters the external atmospheric pressure environment 8, transiting in a upward and tangential flowing path some distance away until encountering the fluid collector 24 wherein a tilted wall 31 (such that the external atmospheric pressure environment 8 extends down between tilted walls all the way to the exit plane 28 and nozzle orifice 29), a component of the fluid collector 24, exhibiting a circumferential geometry, where in some embodiments the wall contour is straight, curved like, spline like, and may exhibit physical separation gap like breaks along its circumference and other embodied features, preventing working fluid 9 exiting the nozzle exit plane orifices 29 from secondarily sonically choking between two adjacent tilted walls 31. The pressure environment 8 extends down between tilted walls 31 to the nozzle orifice 29. The tilted wall 31 scoop like geometry (which may contain radial vanes 25 in another embodiment), of the fluid collector 24, captures and directs fluid downward until it flows into the circumferential disc zone's 4 fluid pump 22. Working fluid 9 originating from the radially innermost circumferential disc zone 4 flows radially outward from adjacent circumferential disc zone 4 to adjacent disc zone 4, crossing over the open air gap 30, and reaching the working fluid accumulator 10, then to the conditioner input fluid line 11, next the working fluid conditioner, pump and recycler 12, next to the conditioner output fluid line 13, next to the hollow center axis drive shaft 14 and back to the radially inner most circumferential disc zone 4 of the DiscThruster Disc 2 in a complete fluid cycle. Discrete component parts illustrated in these embodiment illustrations do not necessarily reflect the preferred embodiment, such that many component and subcomponent parts can be simplified, combined, transferred, and outright eliminated (for example the fluid pump 22 and sonic choking nozzle 23 can be combined, and the nozzle chamber 26 eliminated by lengthening and integrating the converging section 27 to the fluid pump 22), located and integrated with other parts to increase simplicity, efficiency, and reduce overall component and subcomponent part count. Therefore, the minimum number of elements a single circumferential disc zone 4 contains is four; working fluid 9, fluid pump 22, sonic choking nozzle 23, and fluid collector 24. Furthermore, the number of circumferential disc zones 4 shown in the figure is generally reduced for ease of description and does not necessarily reflect the preferred embodiment.

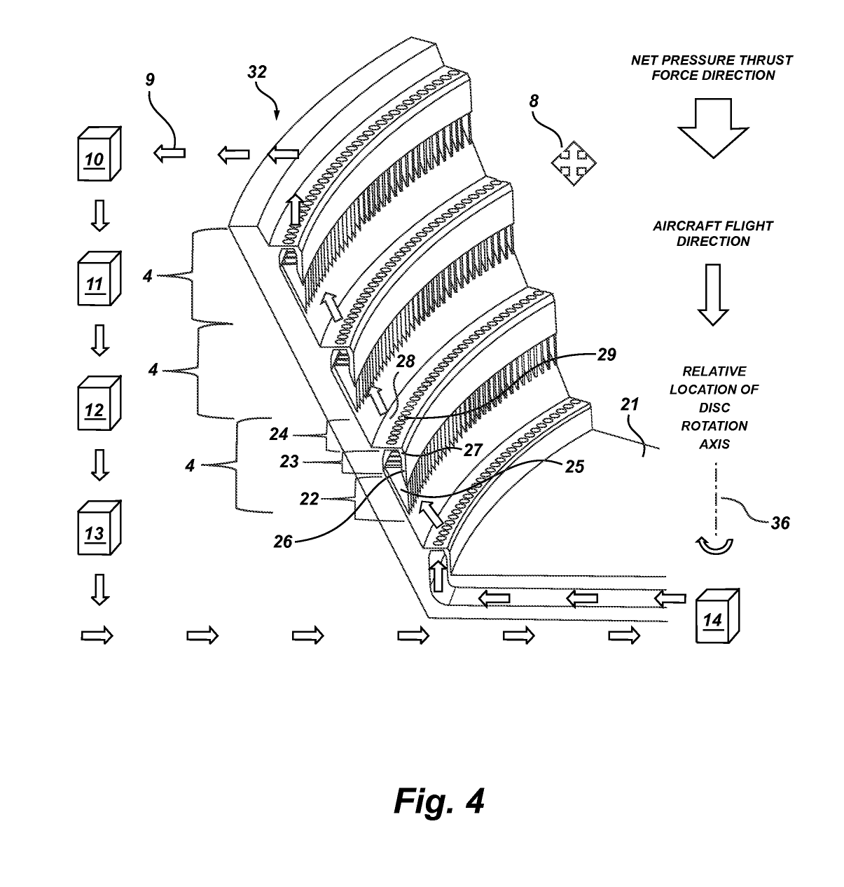

FIG. 4. shows a forth embodiment of a DiscThruster conic disc 32 according to the present invention, being a partial perspective cross-sectional detail view of a conic like geometry. The DiscThruster conic disc 32 exhibits the same principle components and operation as the flat like disc shown previously, except the circumferential disc zone 4 positioning forms an overall straight (although other embodiments exhibit single curves and multiple spline conic like cross-sections) conic cross-section. Each circumferential disc zone 4 contains a plurality of the basic fluid pump 22, sonic choking nozzle 23, and fluid collector 24. Wherein working fluid 9 is pressurized and pumped by the fluid pump 22 enters the sonic choking nozzle 23 where it sonically chokes and exits to the external atmospheric pressure environment 8, and is captured by the fluid collector 24 with the assistance of centrifugal forces created by the DiscThruster conic disc 32 spinning about its disc rotation axis 36. The fluid pump 22 contains radial vanes 25 in this embodiment, operating like a centrifugal pump. The sonic choking nozzle 23 in one embodiment contains a nozzle chamber 26 connecting to and passing working fluid 9 through the converging section 27 (which in another embodiment is a straight cylinder), on to the nozzle exit plane 28, and co-planar nozzle exit plane orifices 29, and out the orifices to the external atmospheric pressure environment 8. Working fluid 9 originating from the radially innermost circumferential disc zone 4 flows radially outward from adjacent circumferential disc zone 4 to adjacent disc zone, crossing over the open air gap 30, reaching the working fluid accumulator 10, then on to the conditioner input fluid line 11, next to the working fluid conditioner, pump and recycler 12, then to the conditioner output fluid line 13 and next to the hollow center axis drive shaft 14, rotating about the disc rotation axis 36, (not exact but relative location only for ease of illustrating) and finally back to the radially inner most circumferential disc zone 4 in a complete fluid cycle, such that all described components are physically and mechanically affixed to the rotating disc base 21. Discrete component parts illustrated in these embodiment illustrations do not necessarily reflect the preferred embodiment, such that many component and subcomponent parts can be simplified, combined, transferred, outright eliminated (for example the fluid pump 22 and sonic choking nozzle 23 can be combined, or the nozzle chamber 26 eliminated by lengthening and integrating the converging section 27 to the fluid pump 22), located and integrated with other parts to increase simplicity, efficiency, and reduce overall part count. Therefore, the minimum number of elements a single circumferential disc zone 4 contains is four; working fluid 9, fluid pump 22, sonic choking nozzle 23, and fluid collector 24. Furthermore, the number of circumferential disc zones 4 shown in the figure is generally reduced for ease of description and does not necessarily reflect the preferred embodiment.

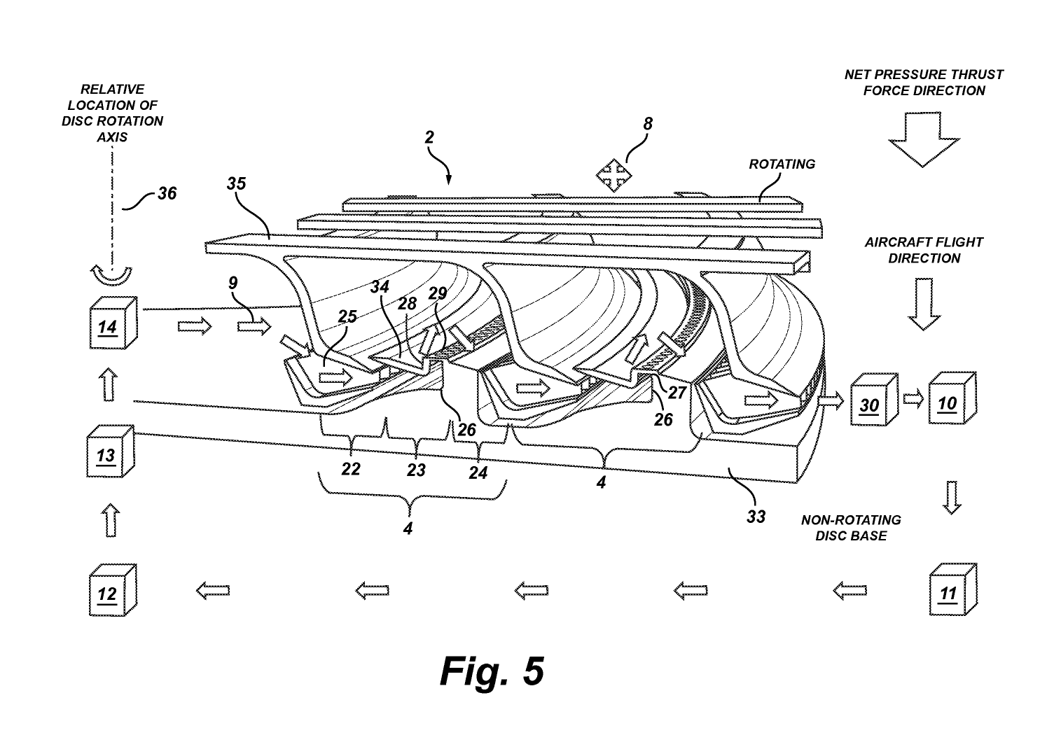

FIG. 5 shows a fifth embodiment of a non-rotating disc base 33 of the DiscThruster disc 2 according to the present invention, being a partial perspective cross-sectional detail view of the disc. Such that the fluid collector 24 and fluid pump 22 rigidly combine together and rotate about the disc rotation axis 36, while the non-rotating base 33 and sonic choking nozzle 23 are stationary. In this embodiment the center axis drive shaft 14 rotates about the disc rotation axis 36 (not exact but relative location only for ease of illustrating), and connects to and spins the combined fluid collector 24 and radial vanes 25 of the fluid pump 22 while the sonic choking nozzle 23 is connected to and stationary with the non-rotating base 33. Working fluid 9 enters the fluid pump 22, encountering the radial vanes 25 acting as centrifugal like pumping vanes (due to Disc 2 rotation about the disc rotation axis 36), pressurizing and transporting fluid to a nozzle-to-collector gap 34, where it passes fluid to the nozzle chamber 26, and then through and sonically choking in the converging section 27 (which in another embodiment is a straight cylinder) and out across the nozzle exit plane 28 and through the nozzle exit plane orifices 29. Working fluid 9 exiting the non-rotating nozzle exit plane 28 through the nozzle exit plane orifices 29, comes into contact with the external atmospheric pressure environment 8 (which extends down to the nozzle exit plane 28) before traveling to and coming into contact with the fluid collector 24 (shown in the illustration as a curving circumferential wall) that attaches to a rotating arm fluid collector 35. Individually or collectively, depending on embodiment, the fluid collector 24 and the rotating arm fluid collector 35 direct working fluid 9 to the fluid pump 22. Working fluid 9 continues travelling outward from radially adjacent circumferential disc zone 4 to disc zone until reaching the open air gap 30, then passing across and reaching the working fluid accumulator 10 that collects it and passes it to the conditioner input fluid line 11, that transfers it to the working fluid conditioner, pump and recycler 12, adjusting fluid thermodynamic state, etc., and pumps it to the conditioner output fluid line 13, and next to the hollow center axis drive shaft 14, and finally then back to the radially innermost circumferential disc zone 4, to complete the fluid recycle. The rotating arm fluid collector 35 has radial wagon wheel like spoke geometry with open gaps between and is mechanically connected to the fluid collector 24, radial vane 25 and fluid pump 22 components, coupling and rotating about the center axis drive shaft 14. The rotating arm fluid collector 35 scoop like geometry captures and redirects working fluid 9 exiting the nozzle exit plane orifice 29 along the radial arm in an increasing radial direction. Rotational speed and circumferential width of the plurality of rotating arm fluid collectors 35 wagon wheel like spokes allows working fluid 9 leaving the nozzle exit plane orifice 29 to be 100% captured (as a goal) by the collector. Some nozzle pressure thrust reduction occurs from shadowing of the nozzle exit plane 28 when the view of the external atmospheric pressure environment 8, by the rotating radial arm fluid collector 35 arm is physically directly over. In another embodiment a primary or secondary fluid collection method using compressed air, other forced air flow, additional rotating arm fluid collectors 35 redirecting working fluid 9 to the fluid collector 24, for purposes of reducing or eliminating fluid losses to the external atmospheric pressure environment 8. Furthermore, the number of circumferential disc zones 4 shown in the figure is generally reduced for ease of description and does not necessarily reflect the preferred embodiment. Discrete component parts illustrated in these limited embodiment illustrations do not necessarily reflect the preferred embodiment, such that many component and subcomponent parts can be simplified, combined, transferred, and outright eliminated (for example the nozzle chamber 26 can be combined with both the converging section 27). Therefore, the minimum component circumferential disc zone 4 contains four basic elements; working fluid 9, fluid pump 22, sonic choking nozzle 23, and fluid collector 24. Furthermore, the number of circumferential disc zones 4 shown in the figure is generally reduced for ease of description and does not necessarily reflect the preferred embodiment. Therefore, the minimum number of elements a single circumferential disc zone 4 contains is four; working fluid 9, fluid pump 22, sonic choking nozzle 23, and fluid collector 24. Furthermore, the number of circumferential disc zones 4 shown in the figure is generally reduced for ease of description and does not necessarily reflect the preferred embodiment.

The invention claimed is:
1. A method of producing pressure thrust propulsion, comprising of a working fluid, a fluid pumping means, a sonic choking nozzle, and a fluid collector means, where said working fluid enters said pumping means, is pressurized through a means and communicates with and passes through said nozzle while being sonically choked through a means, exits said nozzle into view of the external atmospheric pressure environment, where said working fluid communicates with said fluid collector means, that collects through a means and returns said working fluid back to said pumping means, wherein the improvement is lower specific fuel consumption propulsion.
2. The propulsion method of claim 1 wherein the majority of thrust is pressure thrust.
3. The working fluid of claim 1 wherein it is engineered through a means as the lowest practical sonic chocking velocity fluid.
4. The working fluid of claim 1 wherein it is a two-phase gas and liquid combination.
5. The working fluid of claim 1 wherein its thermodynamic state is approximately on the saturated liquid and gas line.
6. The method of propulsion of claim 1 wherein at least some working fluid through a means, enters the external atmospheric pressure environment and does not return to the fluid collector means.
7. The fluid pumping means of claim 1 wherein it is a centrifugal like spinning pump.

The invention claimed is:

1. A method of producing pressure thrust propulsion, comprising of a working fluid, a fluid pumping means, a sonic choking nozzle, and a fluid collector means, where said working fluid enters said pumping means, is pressurized through a means and communicates with and passes through said nozzle while being sonically choked through a means, exits said nozzle into view of the external atmospheric pressure environment, where said working fluid communicates with said fluid collector means, that collects through a means and returns said working fluid back to said pumping means, wherein the improvement is lower specific fuel consumption propulsion.

2. The propulsion method of claim 1 wherein the majority of thrust is pressure thrust.

3. The working fluid of claim 1 wherein it is engineered through a means as the lowest practical sonic chocking velocity fluid.

4. The working fluid of claim 1 wherein it is a two-phase gas and liquid combination.

5. The working fluid of claim 1 wherein its thermodynamic state is approximately on the saturated liquid and gas line.

6. The method of propulsion of claim 1 wherein at least some working fluid through a means, enters the external atmospheric pressure environment and does not return to the fluid collector means.

7. The fluid pumping means of claim 1 wherein it is a centrifugal like spinning pump.

8. The fluid pumping means of claim 1 wherein it is a centrifugal like spinning pump located in and integrated with at least one of the other comprising components.

9. The sonic choking nozzle of claim 1 wherein said nozzle geometry through a means maximizes pressure thrust and minimizes momentum thrust of the working fluid passing through said nozzle.

10. The sonic choking nozzle of claim 1 wherein it contains a fluid converging section along the direction of working fluid flow such that said working fluid sonically chokes through a means at the approximate end of said converging section, where it exits to the external atmospheric pressure environment.

11. The sonic choking nozzle of claim 10 wherein there is a small chamfer like feature at the end of the fluid converging section where the working fluid exits to the external atmospheric pressure environment.

12. The method of propulsion of claim 1 wherein there are a plurality of circumferential disc zones, where each said zone is defined as containing at least one fluid pumping means, at least one sonic choking nozzle, and at least one fluid collector means, such that said zone communicates with adjacent said zones through a means, allowing working fluid exiting the first zone to enter the inlet of the second and so forth, until reaching the last zone wherein said fluid returns back, through a means to the first said zone, in a continuous looping manner, through a means.

13. The method of propulsion of claim 12 wherein working fluid returning back from the last said zone to the first said zone, passes across the open air gap through a means to the working fluid accumulator, and working fluid conditioner, and pump and recycler, in a continuous looping manner, through a means.

14. The method of propulsion of claim 12 wherein there are a plurality of concentric ring like adjacent circumferential disc zones located on a round flat like disc surface, such that adjacent said zones communicate in a fluidic manner with each other through a means, wherein said disc rotates about its disc rotation axis, causing the centrifugal pump like fluid pumping means to pump through a means working fluid in a generally radially outward direction, from the first said zone to the last said zone, wherein said fluid returns back through a means to the first said zone, in a continuous looping manner, through a means.

15. The method of propulsion of claim 14 wherein there are a plurality of concentric ring like adjacent circumferential disc zones located on a round flat like disc surface wherein the centrifugal pump like fluid pumping means, fluid collector means, and rotating arm fluid collector rotate about the said disc rotation axis, while all other components are stationary.

16. The method of propulsion of claim 14 wherein there are a plurality of circumferential disc zones located on a round conic shaped disc surface, such that said round conic increases in diameter with its larger open end facing the external atmospheric pressure environment.

17. The method of propulsion of claim 14 wherein there are a plurality of circumferential disc zones located on a round flat like disc surface, such that said zones are grouped together into independently spinning circumferential ring like disc groups through a means, separated by a circumferential like air gap located between said disc groups, such that working fluid passes between one radially inner to the adjacent radially outer said disc group in a generally radially outward direction, wherein said fluid returns back through a means from the radially outer said disc group to the radially inner said disc group in a continuous looping manner, through a means.

18. The method of propulsion of claim 17 wherein the spinning circumferential ring like disc groups spin rate reduces by approximately half as you go radially outward from adjacent disc group to adjacent disc group.

19. The method of propulsion of claim 14 wherein said round disc is rotated about its disc rotation axis by a powered engine means.

20. The method of propulsion of claim 15 wherein two powered engine means are used, a low power engine and a high power engine, wherein said engines operate in a means to provide fuel efficient operation over a wide power requirement range, through a means.
